(19) United States
(12) Patent Application Publication
(10) Pub. No.: US 2014/0067382 A1
(43) Pub. Date: Mar. 6, 2014

(54) COMPUTING DEVICE AND METHOD FOR DETECTING EVENT IN MONITORING AREA

(71) Applicant: HON HAI PRECISION INDUSTRY CO., LTD., New Taipei (TW)

(72) Inventors: CHING-WEI HO, New Taipei (TW); MU-SAN CHUNG, New Taipei (TW); CHUN-HSIEN LIN, New Taipei (TW); CHE-YI CHU, New Taipei (TW); CHIN-YU CHEN, New Taipei (TW); MIN-BING SHIA, New Taipei (TW)

(73) Assignee: HON HAI PRECISION INDUSTRY CO., LTD., New Taipei (TW)

(21) Appl. No.: 13/778,143

(22) Filed: Feb. 27, 2013

(30) Foreign Application Priority Data
Aug. 29, 2012 (TW) 101131303

(51) Int. Cl. G10L 21/00

(52) U.S. Cl. CPC G10L 21/00
USPC 704/205

(57) ABSTRACT

In a method for detecting an event occurred in a monitoring area, the method defines a reference characteristic parameter for a specific event, and stores the reference characteristic parameter in a storage device of the computing device. The method further obtains a voice stream of the specific event from an IP camera through a wireless network in real time, and extracts a characteristic parameter from the voice stream using a predefined algorithm. The method compares the extracted characteristic parameter with the reference characteristic parameter, and determines that the specific event occurs in the monitoring area if the extracted characteristic parameter accords with the reference characteristic parameter.

### BACKGROUND

1. Technical Field

The embodiments of the present disclosure relate to monitoring systems and methods, and more particularly to a computing device and method for detecting an event in a monitoring area.

2. Description of Related Art

Monitoring equipment, such as IP Cameras, can perform image detections, such as face detections. However, when the monitoring equipment perform the image detections, there are some shortcomings. Some examples of these shortcomings are that a voice stream of the monitoring equipment uses too much network bandwidth. In addition, dealing with the voice stream using too much bandwidth, may increase processing load of a processor of the monitoring equipment.

### BRIEF DESCRIPTION OF THE DRAWINGS

FIG. 1 is a block diagram of one embodiment of a computing device including an event detecting system.

FIG. 2 is a block diagram of one embodiment of function modules of the event detecting system in FIG. 1.

FIG. 3 is a flowchart of one embodiment of a method for detecting an event occurred in a monitoring area.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

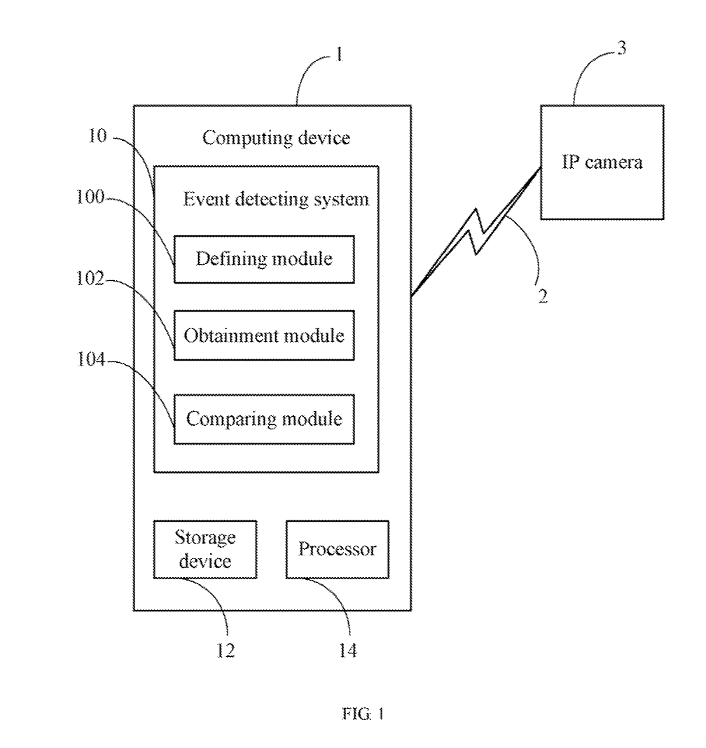

FIG. 1 is a block diagram of one embodiment of a computing device 1. In the embodiment, the computing device 1 includes an event detecting system 10, a storage device 12, and at least one processor 14. The computing device 1 communicates with an IP camera 3 through a wireless network 2, such as an WIFI network, a ZIGBEE network, or other wireless local area network (LAN). The computing device 1 may be a smart phone or a tablet computer or a desktop computer, for example.

The IP camera 3 records a voice stream of a specific event occurring in a monitoring area monitored by the IP camera 3, and sends the voice stream to the computing device 1 through the wireless network 2. The specific event may be a fire alarm or a traffic accident, for example. The monitoring area may be a supermarket, a manufactory workshop, or an intersection of a road, for example.

In one embodiment, the storage device 12 may be an internal storage system, such as a random access memory (RAM) for the temporary storage of information, and/or a read only memory (ROM) for the permanent storage of information. In some embodiments, the storage device 12 may be an external storage system, such as an external hard disk, a storage card, or a data storage medium.

The at least one processor 14 may include a processor unit, a microprocessor, an application-specific integrated circuit, and a field programmable gate array, for example.

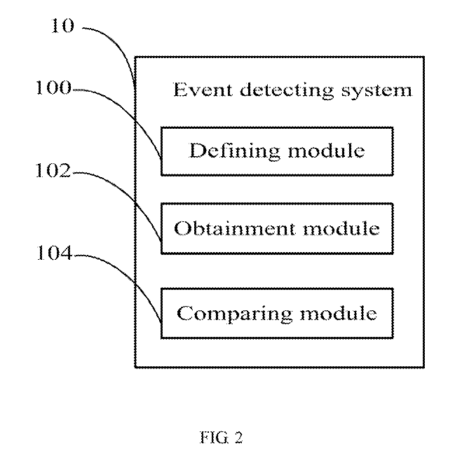

In one embodiment, the event detecting system 10 includes a plurality of function modules (see FIG. 2 below), which include computerized codes or instructions that can be stored in the storage device 12 and executed by the at least one processor 14 to provide a method for detecting an event.

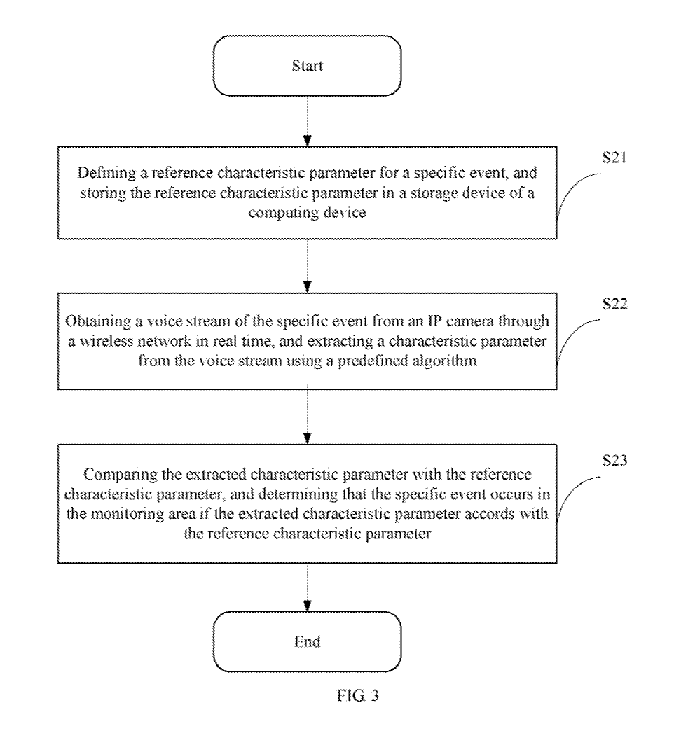

FIG. 2 is a block diagram of one embodiment of the event detecting system 10 included in the computing device 1. In one embodiment, the event detecting system 10 may include a defining module 102, an obtainment module 100, and a comparing module 104. The modules may comprise computerized codes in the form of one or more programs that are stored in the storage device 12 and executed by the at least one processor 14 to provide functions for implementing the modules 100, 102, 104. The functions of the function modules 100, 102, 104 are illustrated in FIG. 3 and described below.

FIG. 3 illustrates a flowchart of one embodiment of a method for detecting an event occurring in a monitoring area using the computing device 1. Depending on the embodiment, additional steps may be added, others removed, and the ordering of the steps may be changed.

In block S21, the defining module 100 defines a reference characteristic parameter of a specific event, and stores the reference characteristic parameter in the storage device 12. In one embodiment, the specific event may be a fire alarm recorded by the IP camera 3, and the reference characteristic parameter may be an average value of an energy of a voice stream of the specific event, wherein the voice stream usually include several kinds of voice signals which have different frequencies and a common amplitude, for example, the voice stream of the fire alarm may include six kinds of frequencies such as 250 Hz, 250.1 Hz, 250.2 Hz, 250.3 Hz, 250.4 Hz and 250.5 Hz, and a common amplitude 588.

In block S22, the obtainment module 102 obtains a voice stream of the specific event from the IP camera 3 through the wireless network 2 in real time, and extracts a characteristic parameter from the voice stream using an algorithm described in greater detail below.

In one embodiment, if the specific event is the fire alarm, just like the above description, the voice stream may include six kinds of voice signals which have different frequencies, for example, 250 Hz, 250.1 Hz, 250.2 Hz, 250.3 Hz, 250.4 Hz, 250.5 Hz. The algorithm may be described as: dividing the voice stream of the specific event into several segments according to a length n bytes (such as n=64 bytes); obtaining a predefined number of segments from the several segments; accumulating the predefined number of segments to make an amplitude of each voice signal of each frequency gain predefined number times; obtaining a proportion relationship between the original amplitude of each voice signal of each frequency and the amplitude of each voice signal of each frequency after gaining predefined number times; and the proportion relationship is the characteristic parameter from the voice stream. In another embodiment, the algorithm may also be an algorithm of Leq Sound Level, which is described as follows:

$${L}_{eq} = 10 log [ \frac{1}{{t}_{2} - {t}_{1}} {\int }_{{t}_{1}}^{{t}_{2}} \frac{{p}_{A}^{2}}{{p}_{0}^{2}} d t ]$$

where, (t2−t1) indicates a time period when the IP camera 3 records the voice stream, and p0 indicates a reference sound pressure (20 μPa), and pa indicates a sound pressure of the voice stream, and an unit of Leq is decibel (dB).

In block S23, the comparing module 104 compares the extracted characteristic parameter with the reference characteristic parameter of the specific event stored in the storage device 12, and determines that the specific event occurs in the monitoring area if the extracted characteristic parameter accords with the reference characteristic parameter. The accordance between the extracted characteristic parameter and the reference characteristic parameter indicates that the specific event occurs in the monitoring area. In the embodiment, the reference characteristic parameter may be a specific value, and if the extracted characteristic parameter is identical to the reference characteristic parameter, the extracted characteristic parameter accords with the reference characteristic parameter. In another embodiment, the reference characteristic parameter may be a value area, if the extracted characteristic parameter is in the value area of the reference characteristic parameter, the extracted characteristic parameter accords with the reference characteristic parameter.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
a storage device;
at least one processor;
one or more programs stored in the storage device and executed by the at least one processor, the one or more programs comprising:
a defining module that defines a reference characteristic parameter for a specific event, and stores the reference characteristic parameter in the storage device of the computing device;
an obtainment module that obtains a voice stream of the specific event from an IP camera through a wireless network in real time, and extracts a characteristic parameter from the voice stream using a predefined algorithm;
a determination module that compares the extracted characteristic parameter with the reference characteristic parameter, and determines that the specific event occurs in the monitoring area if the extracted characteristic parameter accords with the reference characteristic parameter.

2. The communication device according to claim 1, wherein the voice stream includes a plurality of kinds of voice signals which have different frequencies.

3. The communication device according to claim 2, wherein the predefined algorithm is described as follows:
dividing the voice stream of the specific event into several segments according to a predefined length;
obtaining a predefined number of segments from the several segments;
accumulating the predefined number of segments to make an amplitude of each voice signal of each frequency gain predefined number times;
obtaining a proportion relationship between the original amplitude of each voice signal of each frequencies and the amplitude of each voice signal of each frequencies after gaining predefined number times.

4. The communication device according to claim 2, wherein the predefined algorithm is an algorithm of Leq Sound Level, and the reference characteristic parameter is an average of an energy of the voice stream of the specific event.

5. A computerized-method for detecting an event occurred in a monitoring area using a computing device, the method comprising:
defining a reference characteristic parameter for a specific event, and storing the reference characteristic parameter in a storage device of the computing device;
obtaining a voice stream of the specific event from an IP camera through a wireless network in real time, and extracting a characteristic parameter from the voice stream using a predefined algorithm;
comparing the extracted characteristic parameter with the reference characteristic parameter, and determining that the specific event occurs in the monitoring area if the extracted characteristic parameter accords with the reference characteristic parameter.

6. The method according to claim 5, wherein the voice stream includes a plurality of kinds of voice signals which have different frequencies.

7. The method according to claim 6, wherein the predefined algorithm is described as follows:
dividing the voice stream of the specific event into several segments according to a predefined length;
obtaining a predefined number of segments from the several segments;
accumulating the predefined number of segments to make an amplitude of each voice signal of each frequency gain predefined number times;
obtaining a proportion relationship between the original amplitude of each voice signal of each frequencies and the amplitude of each voice signal of each frequency after gaining predefined number times.

8. The method according to claim 6, wherein the predefined algorithm is an algorithm of Leq Sound Level, and the reference characteristic parameter is an average of an energy of the voice stream of the specific event.

9. A non-transitory computer-readable storage medium having stored thereon instructions being executed by a processor of a computing device, causes the computing device to perform a method for detecting a event occurred in a monitoring area, the method comprising:
defining a reference characteristic parameter for a specific event, and storing the reference characteristic parameter in a storage device of the computing device;
obtaining a voice stream of the specific event from an IP camera through a wireless network in real time, and extracting a characteristic parameter from the voice stream using a predefined algorithm;
comparing the extracted characteristic parameter with the reference characteristic parameter, and determining that the specific event occurs in the monitoring area if the extracted characteristic parameter accords with the reference characteristic parameter.

10. The storage medium according to claim 9, wherein the voice stream includes a plurality of kinds of voice signals which have different frequencies.

11. The storage medium according to claim 10, wherein the predefined algorithm is described as follows:
dividing the voice stream of the specific event into several segments according to a predefined length;
obtaining a predefined number of segments from the several segments;
accumulating the predefined number of segments to make an amplitude of each voice signal of each frequency gain predefined number times;
obtaining a proportion relationship between the original amplitude of each voice signal of each frequencies and the amplitude of each voice signal of each frequency after gaining predefined number times.

12. The storage medium according to claim 10, wherein the predefined algorithm is an algorithm of Leq Sound Level, and the reference characteristic parameter is an average of an energy of the voice stream of the specific event.
